(19) United States
(12) Patent Application Publication
(10) Pub. No.: US 2009/0012786 A1
(43) Pub. Date: Jan. 8, 2009

(54) Adaptive Noise Cancellation

(75) Inventors: Xianxian Zhang, San Diego, CA (US); Vishu Ramamoorthy Viswanathan, Plano, TX (US); Takahiro Unno, Richardson, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/167,026

(22) Filed: Jul. 2, 2008

Related U.S. Application Data
(60) Provisional application No. 60/948,237, filed on Jul. 6, 2007.

(51) Int. Cl. G10L 15/20

(52) U.S. Cl. 704/233; 704/E15.039

(57) ABSTRACT

Speech-free noise estimation by cancellation of speech content from an audio input where the speech content is estimated by noise suppression. Adaptive noise cancellation with primary and noise-reference inputs and an adaptive noise cancellation filter from estimating primary noise from noise-reference input. Speech Suppressor (Noise Estimation) applied to noise-reference input provides speech-free noise estimates for noise cancellation in the primary input.

### CROSS-REFERENCE TO RELATED APPLICATIONS

This application claims priority from provisional patent application No. 60/948,237, filed Jul. 6, 2007. The following co-assigned, co-pending patent application discloses related subject matter: application Ser. Nos. 11/165,902, filed Jun. 24, 2005 [TI-35386], and 11/356,800, filed Feb. 17, 2006 [TI-39145]. All of which are herein incorporated by reference.

### BACKGROUND OF THE INVENTION

The present invention relates to digital signal processing, and more particularly to methods and devices for noise estimation and cancellation in digital speech.

In a typical adaptive noise cancellation (ANC) system for speech, a secondary (noise reference) microphone is supposed to pick up speech-free noise which is then adaptively filtered to estimate background noise for cancellation from the noisy speech picked up by a primary microphone. U.S. Pat. No. 4,649,505 provides an example of an ANC system with least mean squares (LMS) control of the adaptive filter coefficients.

However, in a cellphone application, it is not possible to avoid the noise reference microphone from picking up the desired speech signal because the primary and noise reference microphones cannot be placed far from each other due to the small dimensions of a cellphone. That is, there is a problem of speech signal leakage into the noise reference microphone, and a problem of estimating speech-free noise. Indeed, such speech signal leakage into the noise estimate causes partial speech signal cancellation and distortion in an ANC system on a cellphone.

Noise suppression (speech enhancement) estimates and cancels background noise acoustically mixed with a speech signal picked up by a single microphone. Various approaches have been suggested, such as “spectral subtraction” and Wiener filtering which both utilize the short-time spectral amplitude of the speech signal. Ephraim et al, Speech Enhancement Using a Minimum Mean-Square Error Short-Time Spectral Amplitude Estimator, 32 IEEE Tran. Acoustics, Speech, and Signal Processing, 1109 (1984) optimizes this spectral amplitude estimation theoretically using statistical models for the speech and noise plus perfect estimation of the noise parameters.

U.S. Pat. No. 6,477,489 and Virag, Single Channel Speech Enhancement Based on Masking Properties of the Human Auditory System, 7 IEEE Tran. Speech and Audio Processing 126 (March 1999) disclose methods of noise suppression using auditory perceptual models to average over frequency bands or to mask in frequency bands.

### SUMMARY OF THE INVENTION

The present invention provides systems and methods of providing speech-free noise signal for the noise cancellation systems that need noise only signal as an input. The proposed method is to extract the speech part from the noisy speech signal, and subtract speech-only signal from the noisy speech signal, and the output is noisy-only signal. The system described in this patent called speech suppressor. Applications of speech suppressor for adaptive noise cancellation provide good performance with low computational complexity.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1a-1c are the functions of preferred embodiment speech-free noise estimation and application to adaptive noise cancellation plus a system.

FIGS. 2a-2e illustrate noise suppression.

FIGS. 3a-3b show a processor and network communication.

FIGS. 4a-4d are experimental results.

FIGS. 5a-5b illustrate VAD results.

### DESCRIPTION OF THE PREFERRED EMBODIMENTS

### 1. Overview

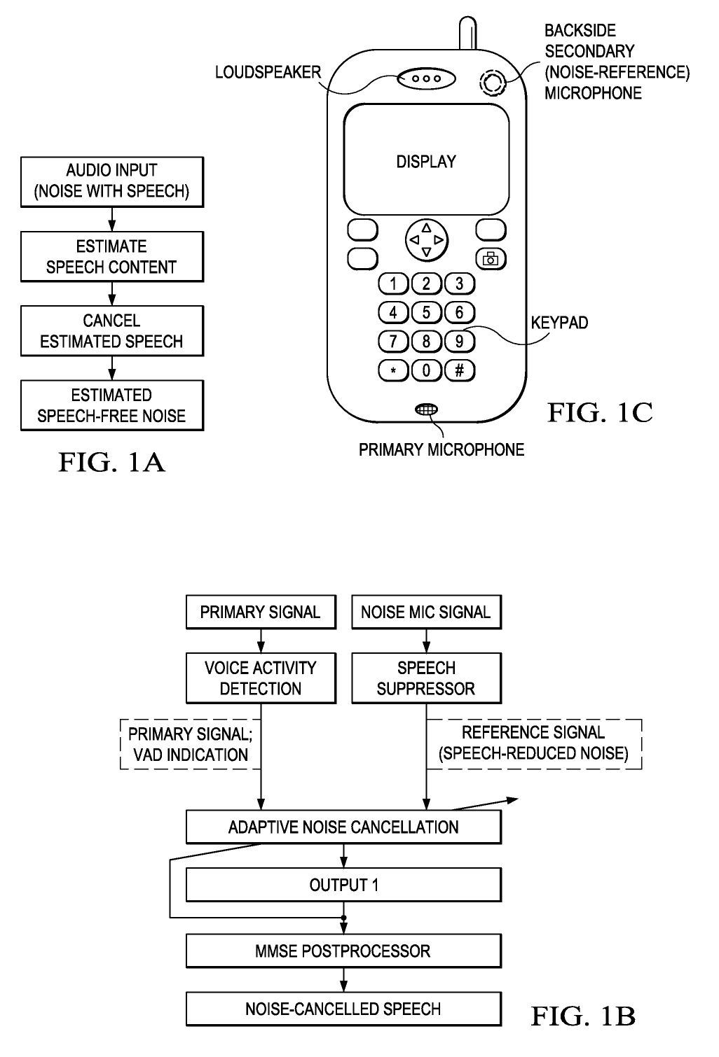

Preferred embodiment noise estimation methods cancel speech (and music) from an input to generate a speech-free noise estimate. FIG. 1a is a flowchart. The speech-free noise estimate can then be: used in applications such as adaptive noise cancellation (ANC) in cellphones; FIG. 1b is a block diagram of an ANC system and FIG. 1c illustrates a cellphone embodiment. Other applications of the speech-free noise include Generalized Sidelobe Canceller (GSC), adaptive beamforming (CSA-BF), et cetera.

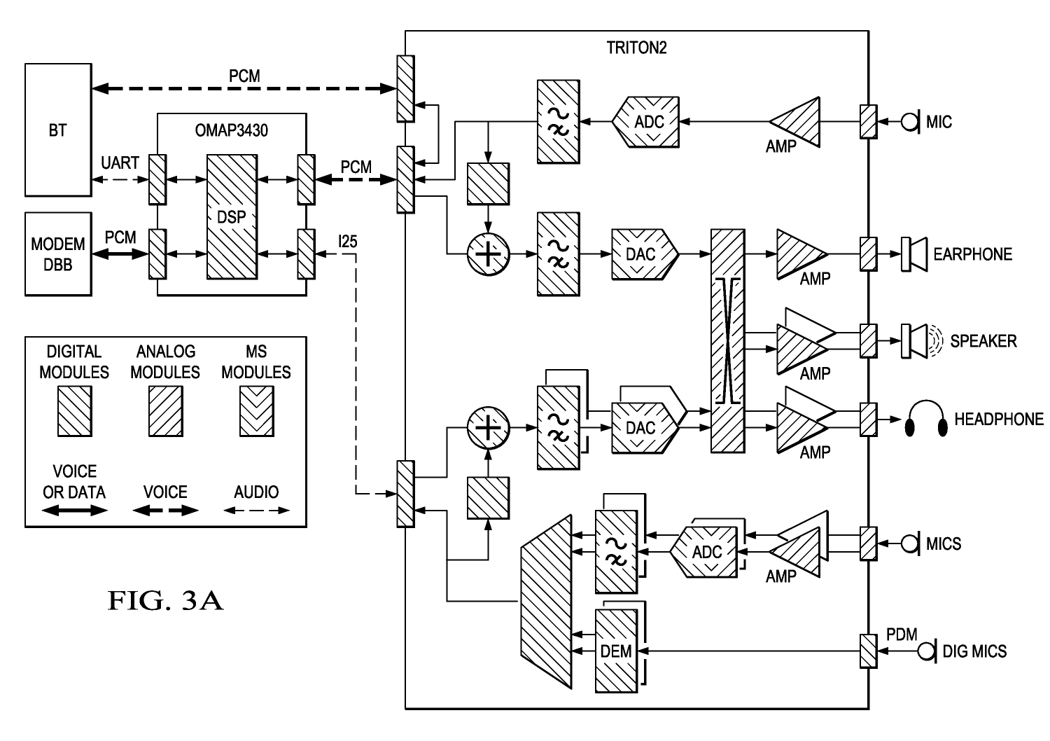

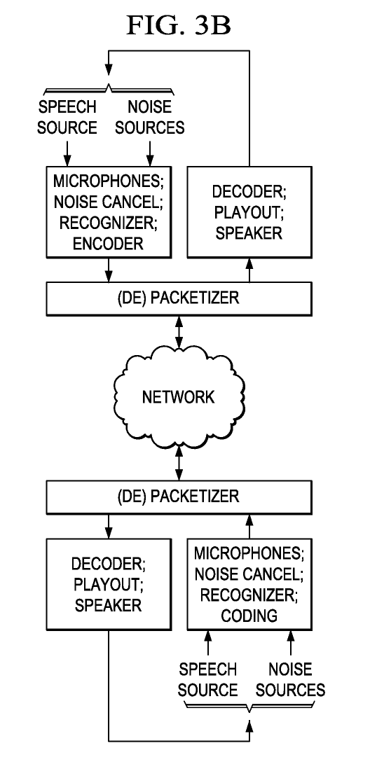

Preferred embodiment systems, such as cellphones (which may support voice recognition), in noisy environments perform preferred embodiment methods with digital signal processors (DSPs) or general purpose programmable processors or application specific circuitry or systems on a chip (SoC) such as both a DSP and RISC processor on the same chip; FIG. 3a shows functional blocks of a processor. A program stored in an onboard ROM or external flash EEPROM for a DSP or programmable processor could perform the signal processing. Analog-to-digital converters and digital-to-analog converters provide coupling to the real world, and modulators and demodulators (plus antennas for air interfaces) provide coupling for transmission waveforms. The noise-cancelled speech can also be encoded, packetized, and transmitted over networks such as the Internet; see FIG. 3b.

### 2. Speech-Free Noise Estimation

Preferred embodiment methods estimate speech-free (and/or music-free) noise by estimating the speech (and/or music) content of an input audio signal and then cancelling the speech (and/or music) content from the input audio signal. That is, the speech-free noise is generated by applying speech suppressor to the input; see FIG. 1a. Preferred embodiments apply a noise suppression method to an input audio signal in order to estimate the speech (and/or music) content. Various noise suppression methods are known and could be used, such as spectral subtraction, Wiener filtering, auditory perceptual models, frequency-dependent gain, etc. The following section provides some details of a preferred embodiment implementation of the speech suppression.

### 3. Frequency-Dependent Gain Speech Suppression

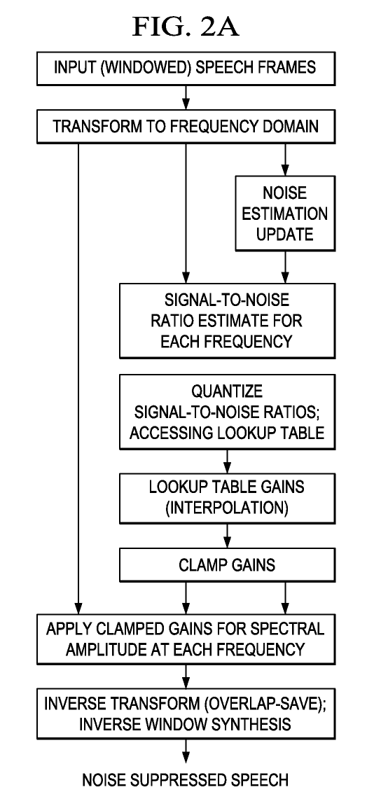

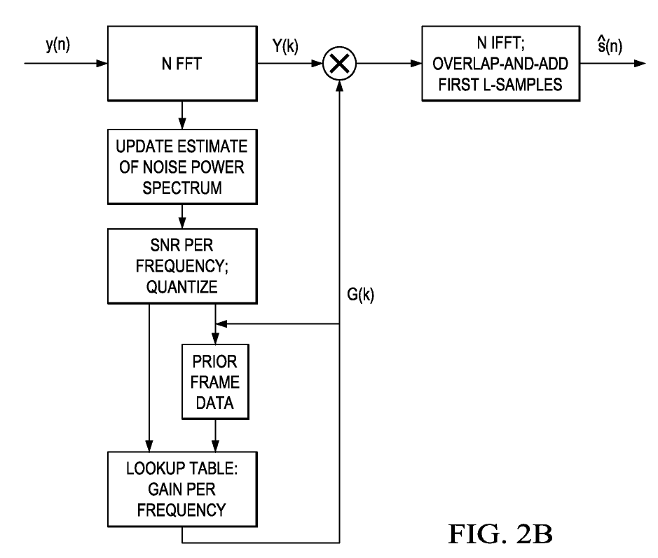

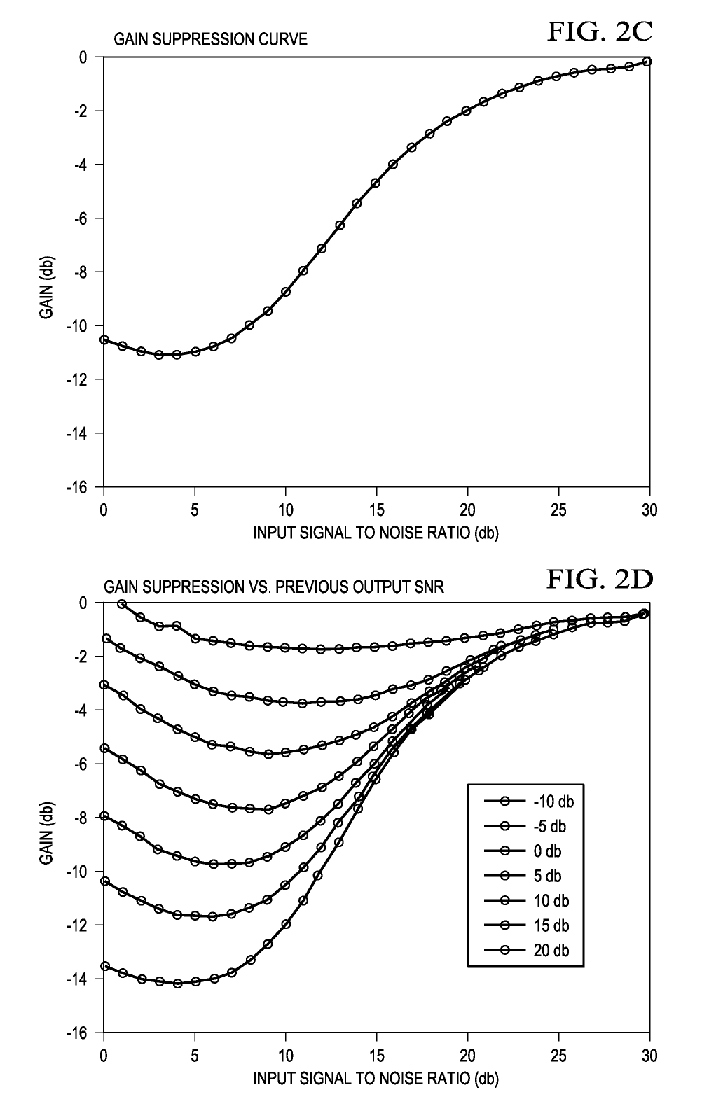

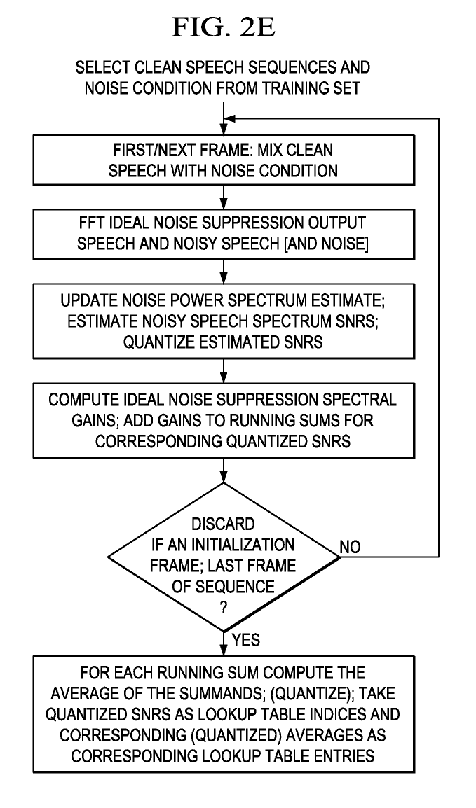

First preferred embodiment methods apply a frequency-dependent gain to an audio input to estimate the speech (to be removed) where an estimated SNR determines the gain from a codebook based on training with a minimum mean-squared error metric. Cross-referenced patent application Ser. No. 11/356,800 discloses this frequency-dependent gain method of noise suppression; also see FIG. 2a.

In more detail, first preferred embodiment methods of generating speech-free noise estimates proceed as follows. Presume a digital sampled noise signal, w(n), which has additive unwanted speech, s(n), so that the observed signal, y(n), can be written as:

y(n)=s(n)+w(n)

The signals are partitioned into frames (either windowed with overlap or non-windowed without overlap). Initially, consider the simple case of N-point FFT transforms; the following sections will include gain interpolations, smoothing over time, gain clamping, and alternative transforms. Typical values could be 20 ms frames (160 samples at a sampling rate of 8 kHz) and a 256-point FFT.

N-point FFT input consists of M samples from the current frame and L samples from the previous frame where M+L=N. L samples will be used for overlap-and-add with the inverse FFT; see FIG. 2b. Transforming gives:

Y(k,r)=S(k,r)+W(k,r)

where Y(k, r), S(k, r), and W(k, r) are the (complex) spectra of s(n), w(n), and y(n), respectively, for sample index n in frame r, and k denotes the discrete frequency bin in the range k=0, 1, 2, . . . , N−1 (these spectra are conjugate symmetric about the frequency bin (N−1)/2). Then the preferred embodiment estimates the speech by a scaling in the frequency domain:

Ŝ(k,r)=G(k,r)Y(k,r)

where Ŝ(k, r) estimates the noise-suppressed speech spectrum and G(k, r) is the noise suppression filter gain in the frequency domain. The preferred embodiment G(k, r) depends upon a quantization of ρ(k, r) where ρ(k, r) is the estimated signal-to-noise ratio (SNR) of the input signal for the kth frequency bin in the rth frame and Q indicates the quantization:

G(k,r)=lookup{Q(ρ(k,r))}

In this equation lookup{ } indicates the entry in the gain lookup table (constructed in the next section), and:

ρ(k,r)=|Y(k,r)|²/|Ŵ(k,r)|²

where Ŵ(k, r) is a long-run noise spectrum estimate which can be generated in various ways.

A preferred embodiment long-run noise spectrum estimation updates the noise energy level for each frequency bin, |Ŵ(k r)|², separately:

$$\begin{matrix}{\vert \hat{W} ( k , r ) \vert}^{2} = \begin{matrix}κ {\vert \hat{W} ( k , r - 1 ) \vert}^{2} & if {\vert Y ( k , r ) \vert}^{2} > κ {\vert \hat{W} ( k , r - 1 ) \vert}^{2}\end{matrix} \\ = λ \begin{matrix}{\vert \hat{W} ( k , r - 1 ) \vert}^{2} & if {\vert Y ( k , r ) \vert}^{2} < λ {\vert \hat{W} ( k , r - 1 ) \vert}^{2}\end{matrix} \\ = \begin{matrix}{\vert Y ( k , r ) \vert}^{2} & otherwise\end{matrix}\end{matrix}$$

where updating the noise level once every 20 ms uses κ=1.0139 (3 dB/sec) and λ=0.9462 (−12 dB/sec) as the upward and downward time constants, respectively, and |Y(k, r)|² is the signal energy for the kth frequency bin in the rth frame.

Then the updates are minimized within critical bands:

|Ŵ(k,r)|²=min{|Ŵ(k_{lb},r)|², . . . , |Ŵ(k,r)|², . . . , |Ŵ(k_{ub},r)|²}

where k lies in the critical band k_{lb}≦k≦k_{ub}. Recall that critical bands (Bark bands) are related to the masking properties of the human auditory system, and are about 100 Hz wide for low frequencies and increase logarithmically above about 1 kHz. For example, with a sampling frequency of 8 kHz and a 256-point FFT, the critical bands (in multiples of 8000/256=31.25 Hz) would be:

| critical band | frequency range |
|---|---|
| 1 | 0-94 |
| 2 | 94-187 |
| 3 | 188-312 |
| 4 | 313-406 |
| 5 | 406-500 |
| 6 | 500-625 |
| 7 | 625-781 |
| 8 | 781-906 |
| 9 | 906-1094 |
| 10 | 1094-1281 |
| 11 | 1281-1469 |
| 12 | 1469-1719 |
| 13 | 1719-2000 |
| 14 | 2000-2312 |
| 15 | 2313-2687 |
| 16 | 2687-3125 |
| 17 | 3125-3687 |
| 18 | 3687-4000 |

Thus the minimization is on groups of 34 ks for low frequencies and at least 10 for critical bands 14-18.

Lastly, the speech-free noise spectrum is estimated by:

$$\begin{matrix}{W}_{speech - free} ( k , r ) = Y ( k , r ) - \hat{S} ( k , r ) \\ = Y ( k , r ) [ 1 - G ( k , r ) ]\end{matrix}$$

FIG. 2c illustrates a preferred embodiment noise suppression curve; that is, the curve defines a gain as a function of input-signal SNR. The thirty-one points on the curve (indicated by circles) define entries for a lookup table: the horizontal components (log ρ(k, r)) are uniformly spaced at 1 dB intervals and define the quantized SNR input indices (addresses), and the corresponding vertical components are the corresponding G(k, r) entries.

Thus the preferred embodiment noise suppression filter G(k, r) attenuates the noisy signal with a gain depending upon the input-signal SNR, ρ(k, r), at each frequency bin. In particular, when a frequency bin has large ρ(k, r), then G(k, r)≈1 and the spectrum is not attenuated at this frequency bin. Otherwise, it is likely that the frequency bin contains significant noise, and G(k, r) tries to remove the noise power by attenuation.

The noise-suppressed speech spectrum Ŝ(k, r) and thus W_{speech-free}(k, r) are taken to have the same distorted phase characteristic as the noisy speech spectrum Y(k, r); that is, presume arg{Ŝ(k, r)}=arg{W_{speech-free}(k, r)}=arg{Y(k, r)}. This presumption relies upon the insignificance of the phase information of a speech signal.

Lastly, apply N-point inverse FFT (IFFT) to W_{speech-free}(k, r), and use L samples for overlap-and-add to thereby recover the speech-free noise estimate, w_{speech-free}(n), in the rth frame which can be filtered to estimate noise for cancellation in the noisy speech primary input.

Preferred embodiment methods to construct the gain lookup table (and thus gain curves as in FIGS. 2c-2d by interpolation) are essentially codebook mapping methods (generalized vector quantization). FIG. 2e illustrates a first preferred embodiment construction method which proceeds as follows.

First, select a training set of various clean digital speech sequences plus various digital noise conditions (sources and powers). Then, for each sequence of clean speech, s(n), mix in a noise condition, w(n), to give a corresponding noisy sequence, y(n), and for each frame (excluding some initialization frames) in the sequence successively compute the pairs (ρ(k, r), G_{ideal}(k, r)) by iterating the following steps (a)-(e). Lastly, cluster (quantize) the computed pairs to form corresponding (mapped) codebooks and thus a lookup table.

(a) For a frame of the noisy speech compute the spectrum, Y(k, r), where r denotes the frame, and also compute the spectrum of the corresponding frame of ideal noise suppression output Y_{ideal}(k, r). Typically, ideal noise suppression output is generated by digitally adding noise to the clean speech, but the added noise level is 20 dB lower than that of noisy speech signal.

(b) For frame r update the noise spectral energy estimate, |Ŵ(k, r)|², as described in the foregoing; initialize |Ŵ(k, r)|hu 2 with the frame energy during an initialization period (e.g., 60 ms).

(c) For frame r compute the SNR for each frequency bin, ρ(k, r), as previously described: ρ(k, r)=|Y(k, r)|²/|Ŵ(k, r)|².

(d) For frame r compute the ideal gain for each frequency bin, G_{ideal}(k, r), by G_{ideal}(k,r)=|Y_{ideal}(k, r)|/|Y(k, r)|.

(e) Repeat steps (a)-(d) for successive frames of the sequence.

The resulting set of pairs (ρ(k, r), G_{ideal}(k, r)) from the training set are the data to be clustered (quantized) to form the mapped codebooks and lookup table.

One simple approach first quantizes the ρ(k, r) (defines an SNR codebook) and then for each quantized ρ(k, r) defines the corresponding G(k,r) by just averaging all of the G_{ideal}(k,r) which were paired with ρ(k, r)s that give the quantized ρ(k, r). This averaging can be implemented by adding the G_{ideal}(k,r)s computed for a frame to running sums associated with the quantized ρ(k, r)s. This set of G(k,r)s defines a gain codebook mapped from the SNR codebook. For the example of FIG. 2b, quantize ρ(k, r) by rounding off log ρ(k, r) to the nearest 0.1 (1 dB) to give Q(ρ(k,r)). Then for each Q(ρ(k,r)), define the corresponding lookup table entry, lookup{Q(ρ(kr))}, as the average from the running sum; this minimizes the mean square errors of the gains and completes the lookup table.

Note that graphing the resulting set of points defining the lookup table and connecting the points (interpolating) with a curve yields a suppression curve as in FIG. 2c. The particular training set for FIG. 2c was eight talkers of eight languages (English, French, Chinese, Japanese, German, Finnish, Spanish, and Russian) recording twelve sentences each and mixed with four diverse noise sources (train, airport, restaurant, and babble) to generate the noisy speech; the noise SNR is about 10 dB, which insures multiple data points throughout the log ρ(k, r) range of 0-30 dB used for FIG. 2c. The noise SNR of ideal noise suppression speech is 30 dB, which is 20 dB lower than noise SNR of noisy speech.

4. Adaptive Noise Cancellation with Speech-Free Noise Estimate.

FIG. 1c illustrates a cellphone with a primary microphone and a secondary noise-reference microphone, and FIG. 1b shows functions of an adaptive noise cancellation (ANC) preferred embodiment which could be implemented on the cellphone of FIG. 1c. The adaptive noise cancellation system estimates speech-free noise from the noise-reference microphone input in the speech suppressor by using the preferred embodiment of preceding section 2. The adaptive filtering uses this speech-free noise to estimate and cancel the noise content from the noisy speech primary microphone input. The voice activity detection (VAD) for the primary input helps avoid false speech detection and noise cancelling.

In more detail, denote the sampled primary microphone input as y(n) and the sampled noise reference microphone input as y_{ref}(n). The primary input is presumed to be of the form y(n)=s(n)+z(n) where s(n) is the desired noise-free speech and z(n) is noise at the primary microphone; and the noise-reference input is presumed to be of the form y_{ref}(n)=s_{ref}(n)+z_{ref}(n) where sᵣₑⱼ(n) is leakage speech related to the noise-free speech s(n) and z_{ref}(n) is speech-free noise related to the noise z(n). Thus the speech suppressor of FIG. 1b is to remove s_{ref}(n) from y_{ref}(n) to estimate z_{ref}(n) which the adaptive filtering converts to an estimate of w(n) for cancellation from y(n) to yield an estimate of s(n). The VAD helps detect frames Where s(n)=s_{ref}(n)=0 and which can be used for updating the adaptive filter coefficients. The post-processor MMSE in FIG. 1b provides further noise suppression to the output of the ANC.

Preceding sections 2-3 described the operation of a preferred embodiment speech suppressor, and following sections 5-6 describe the voice activity detection and the adaptive noise cancellation filtering.

### 5. Voice Activity Detection

A nonlinear Teager Energy Operator (TEO) energy-based voice activity detector (VAD) applied to frames of the primary input signal controls filter coefficient updating for the adaptive noise cancellation (ANC) filter; that is, when the VAD declares no voice activity, the ANC filter coefficients are updated to converge the filtered speech-free noise reference to the primary input.

The VAD proceeds as follows. First compute the average energy of the samples in the current frame (frame r) of primary input:

Eₐᵥₑ(r)=(1/N)Σ₀_{_{≦}}ₙ_{_{≦}}_{N}_{_{—}}₁{y(n,r)²−y(n+1,r)y(n−1,r)}

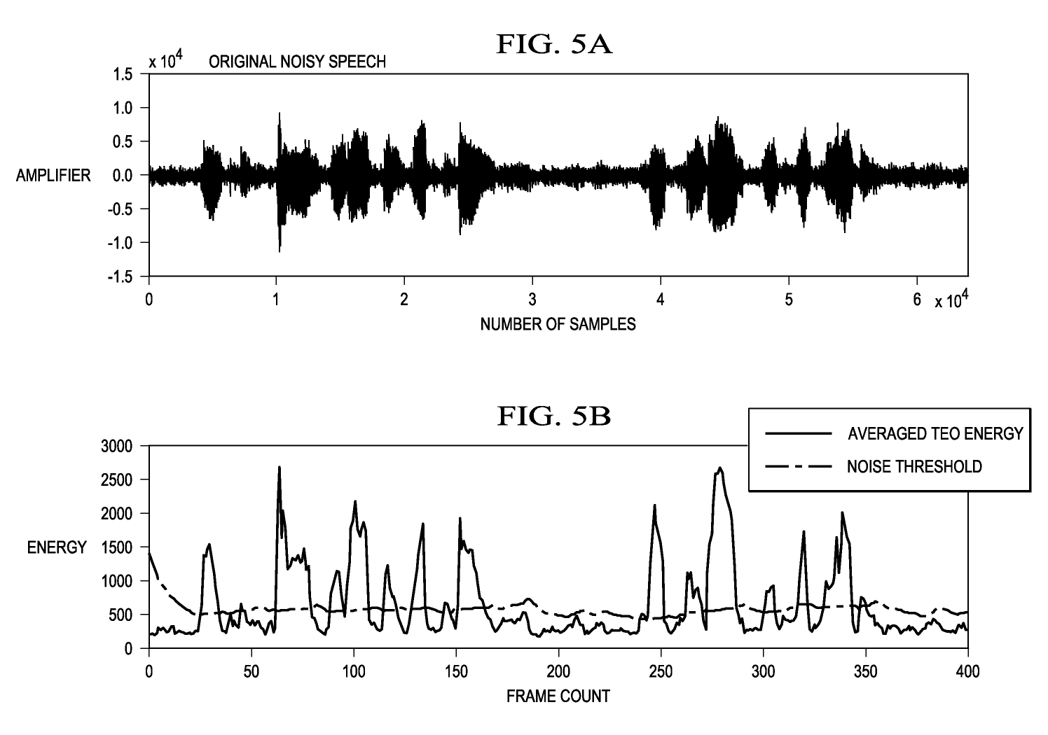

Then, compare Eₐᵥₑ(r) with an adaptive threshold Eₜₕᵣₑₛₕ(r), and when Eₐᵥₑ(r)≦Eₜₕᵣₑₛₕ(r) declare no voice activity for the frame. Lastly, update the threshold by:

$$\begin{matrix}{E}_{thresh} ( r + 1 ) = \begin{matrix}α {E}_{thresh} ( r ) + ( 1 - α ) {E}_{ave} ( r ) & if {E}_{ave} ( r ) > {λ}_{1} {E}_{threshl} ( r )\end{matrix} \\ = \begin{matrix}β {E}_{thresh} ( r ) + ( 1 - β ) {E}_{ave} ( r ) & if {E}_{ave} ( r ) < {λ}_{2} {E}_{threshl} ( r )\end{matrix} \\ = \begin{matrix}γ {E}_{thresh} ( r ) + ( 1 - γ ) {E}_{ave} ( r ) & otherwise\end{matrix}\end{matrix}$$

where α, β, γ, λ₁, and λ₂ are constants which control the level of the noise threshold. Typical values would be α=0.98, β=0.95, γ=0.97, λ₁=1.425, and λ₂=1.175. FIGS. 5a-5b show the typical results of applying this VAD to a noisy speech frame: FIG. 5a shows the noise speech and FIG. 5b the threshold of the VAD.

An alternative simple voice activity detector (VAD) is based on signal energy and long-run background noise energy: let Eₙₒᵢₛₑ(r)=Σ₀_{_{≦}}ₖ_{_{≦}}_{N}_{_{—}}₁|Ŵ(k, r)|² be the frame r estimated noise energy, let E_{fr}(r)=Σ₀_{_{≦}}ₖ_{_{≦}}_{N}_{_{—}}₁|Y(k, r)|² be the frame r signal energy, and let Eₛₘ(r)=Σ₀_{_{≦}}ⱼ_{ᵢ}_{_{≦}}ⱼλⱼE_{fr}(r−j) be the frame signal energy smoothed over J+1 frames, then if Eₛₘ(r)−Eₙₒᵢₛₑ(r) is less than a threshold, deem frame r to be noise. When the input frame r is declared to be noise, increase the noise power estimate for each frequency bin, |Ŵ(k, r)|², by 5 dB (e.g., multiply by 3.162) prior to computing the input SNR. This increases the chances that the noise suppression gain will reach the minimum value (e.g., Gₘᵢₙ) for background noise.

### 6. Adaptive Noise Cancellation

FIG. 1b shows a preferred embodiment adaptive noise cancellation (ANC) filtering which uses the preferred embodiment speech-free noise estimation. Using the primary (microphone) sampled and framed input y(n, r) and the speech-free noise estimate z_{speech-free}(n, r) derived from the noise-reference (microphone) sampled and framed input y_{ref}(n, r), the adaptive noise cancellation filter generates z̅(n, r), an estimate of the noise content of y(n, r), and subtracts it from y(n, r) to output ŝ(n, r), an estimate of the speech content of y(n, r). Explicitly, with the ANC filter coefficients denoted h(m, r) for 0≦m≦L−1 (filter length L) and with negative frame sample indexes for z_{speech-free}(n−m, r) understood as samples from prior frames:

z̅(n,r)=Σ₀_{_{≦}}ₘ_{_{≦}}_{L}_{_{—}}₁z_{speech-free}(n−m,r)h(m,r)

\hat{s}(n,r)=y(n,r)− z̅(n,r)

The adaptive filter coefficients, h(m, r), are updated (by a least mean squares method) during VAD-declared non-speech frames for the primary input. Ideally, for non-speech frames s(n, r)=0; so the error (estimated speech) term e(n, r)=y(n, r)− z̅(n, r) should be 0. LMS filter coefficient updating minimizes Σ₀_{_{≦}}ₙ_{_{≦}}_{N}_{_{—}}₁e(n, r)² by computing the gradient of Σ₀_{_{≦}}ₙ_{_{≦}}_{N}_{_{—}}₁e(n, r)² with respect to the coefficients h(m r), and then incrementing the coefficients along the gradient:

h(m,r+1)=h(m,r)+2μΣ₀_{_{≦}}ₙ_{_{≦}}_{N}_{_{—}}₁z_{speech-free}(n−m,r)e(n,r)

where μ is the increment step size which controls the convergence rate and the filter stability.

Thus with a sequence of non-speech frames, the filter coefficients are LMS converged; and during intervening frames with speech activity, the filter coefficients are used without change to estimate the noise for cancellation.

An implementation of the ANC filtering and the coefficient updating could be based on computations in the frequency domain so that the ANC filtering convolution becomes a product; this reduces computational complexity. Indeed, the speech suppression plus ANC filtering and noise cancellation would include the overlap-and-add IFFT of terms like:

$$\begin{matrix}\hat{S} ( k , r ) = Y ( k , r ) - {Z}^{⋒} k , r \text{)} \\ = Y ( k , r ) - {Z}_{speech - free} ( k , r ) H ( k , r ) ) \\ = Y ( k , r ) - {Y}_{ref} ( k , r ) [ 1 - G ( k , r ) ] H ( k , r )\end{matrix}$$

In summary, the overall preferred embodiment adaptive noise cancellation method includes the steps of:

(a) sampling and framing both a primary noisy speech input and a noise-reference input (typically from a primary microphone and a noise-reference microphone); the framing may include windowing.

(b) applying speech suppression to the noise-reference frames to estimate speech-free noise frames (i.e., preferred embodiment speech-free noise estimation);

(c) applying a voice activity detector to the primary frames; when there is no voice activity, update the coefficients of an adaptive noise cancellation (ANC) filter by converging the filtered speech-free noise frames to the non-speech primary frames (the convergence may be by least mean squares).

(d) applying the ANC filter to the speech-free noise estimate to get an estimate of the primary noise.

(e) subtracting the estimate of primary noise from the primary input to get an estimate of noise-cancelled speech (or when the VAD declares no voice activity, updating the adaptive filter coefficients).

An alternative adaptive filter usable by ANC is a frequency-domain adaptive filter. It features fast convergence, robustness, and relatively low complexity. Cross-referenced patent application Ser. No. 11/165,902 discloses this frequency-domain adaptive filter;

### 7. Smoothing Over Time

Further preferred embodiment speech suppressor and methods provide a smoothing in time; this can help suppress artifacts such as musical noise. A first preferred embodiment extends the foregoing lookup table which has one index (current frame quantized input-signal SNR) to a lookup table with two indices (current frame quantized input-signal SNR and prior frame output-signal SNR); this allows for an adaptive noise suppression curve as illustrated by the family of curves in FIG. 2d. In particular, as a lookup table second index take a quantization of the product of the prior frame's gain multiplied by the prior frame's input-signal SNR. FIG. 2d illustrates such a two-index lookup table with one index (quantized log ρ(k, r)) along the horizontal axis and the second index (quantized log(G(k, r−1))+log(ρ(k, r−1))) the label for the curves. The codebook mapping training can use the same training set and have steps analogous to the prior one-index lookup table construction; namely:

(a) For a frame of the noisy speech compute the spectrum, Y(k, r), where r denotes the frame, and also the compute the spectrum of the corresponding frame of ideal noise suppression output Y_{ideal}(k, r).

(b) For frame r update the noise spectral energy estimate, |\hat{Z}(k r)|², as described in the foregoing; initialize |\hat{Z}(k, r)|² with frame energy during initialization period (e.g. 60 ms).

(c) For frame r compute the SNR for each frequency bin, ρ(k, r), as previously described: ρ(k, r)=|Y(k, r)|²/|\hat{Z}(k, r)|².

(d) For frame r compute the ideal gain for each frequency bin, G_{ideal}(k, r), by G_{ideal}(k,r)²=|S(k, r)|²/|Y(k, r)|².

(e) For frame r compute the products G_{ideal}(k, r)ρ(k, r) and save in memory for use with frame r+1.

(f Repeat steps (a)-(e) for successive frames of the sequence.

The resulting set of triples (ρ(k, r), G_{ideal}(k, r−1)ρ(k, r−1), G_{idea}(k,r)) for the training set are the data to be clustered (quantized) to form the codebooks and lookup table; the first two components relate to the indices for the lookup table, and the third component relates to the corresponding lookup table entry. A preferred embodiment illustrated in FIG. 2d quantizes ρ(k, r) by rounding off log ρ(k, r) to the nearest 0.1 (1 dB) and quantizes G_{ideal}(k, r−1)ρ(k, r−1) by rounding off log [G_{ideal}(k, r−1)ρ(k, r−1)] to the nearest 0.5 (5 dB) to be the two lookup table indices (first codebook), and defines the lookup table (and mapped codebook) entry G(k,r) indexed by the pair (quantized ρ(k, r), quantized G_{ideal}(k, r−1)ρ(k, r−1)) as the average of all of the G_{ideal}(k, r) in triples with the corresponding ρ(k, r) and G_{ideal}(k, r−1)ρ(k, r−1). Again, this may be implemented as the frames are being analyzed by adding each G_{ideal}(k,r) to a running sum for the corresponding index pair. Thus the two-index lookup table amounts to a mapping of the codebook for the pairs (SNR, prior-frame-output) to a codebook for the gain.

FIG. 2d shows that the suppression curve depends strongly upon the prior frame output. If the prior frame output was very small, then the current suppression curve is aggressive; whereas, if the prior frame output was large, then the current frame suppression is very mild. FIG. 2b illustrates the overlap-and-add with the prior frame data used in the gain table lookup.

Alternative smoothing over time approaches do not work as well. For example, simply use the single index lookup table for the current frame gains G(k, r) and define smoothed current frame gains Gₛₘₒₒₜₕ(k, r) by:

Gₛₘₒₒₜₕ(k,r)=αGₛₘₒₒₜₕ(k,r−1)+(1−α)G(k,r)

where α is a weighting factor (e.g. α=0.9). However, this directly applying smoothing to the gain would reduce the time resolution of the gain, and as a result, it would cause echo-like artifacts in noise-suppressed output speech.

### 8. Experimental Results

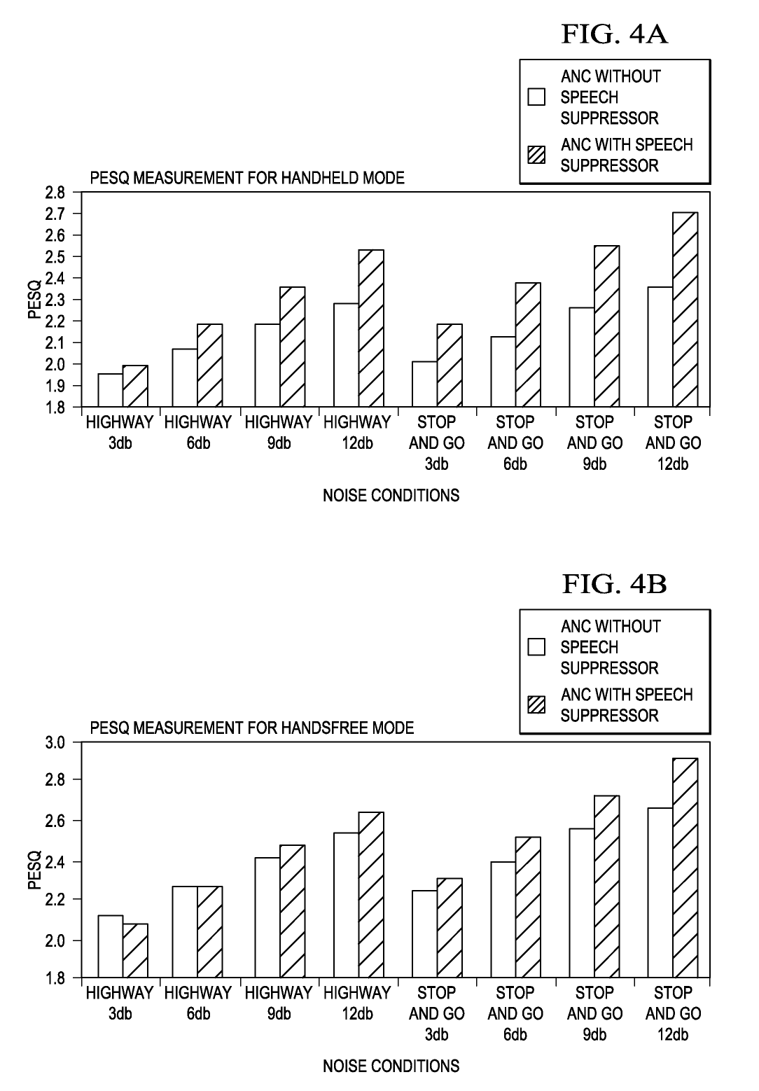

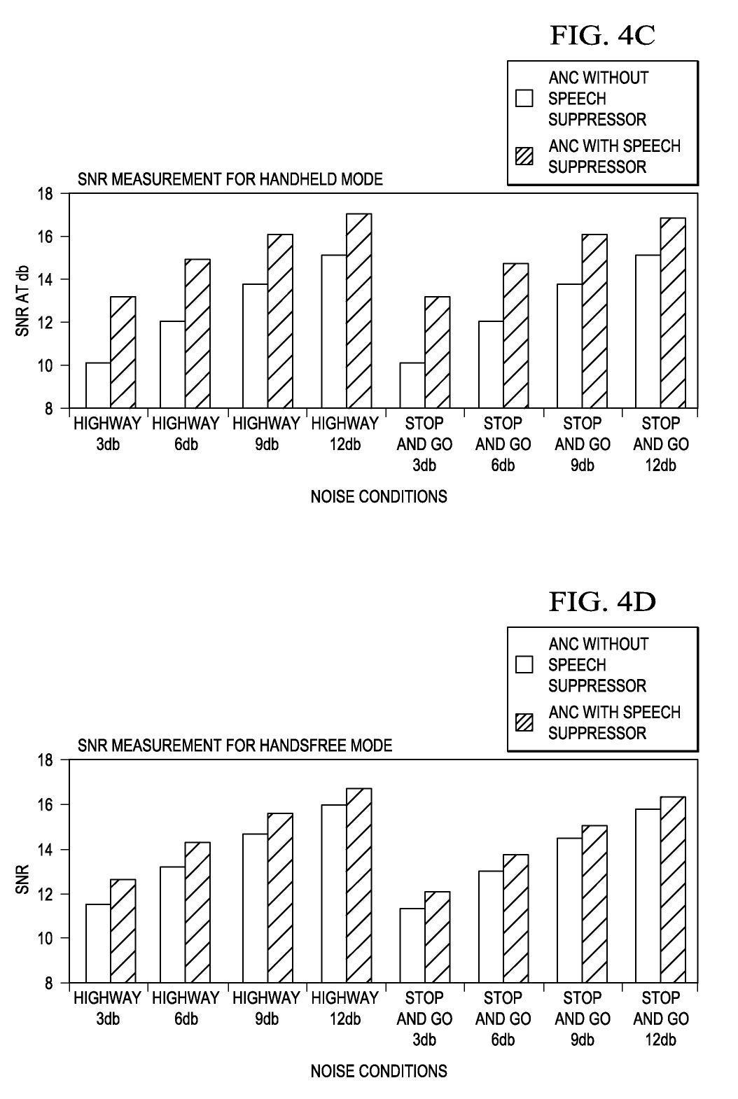

FIGS. 4a-4b show perceptual speech quality results. ITU tool PESQ is used to measure the objective speech quality of preferred embodiment ANC output. The speech collected in quiet environments is used as a reference. Results from this test show that using the speech suppressor results in PESQ improvement by up to 0.35 for a cellphone in handheld mode and 0.24 for hands-free mode.

FIGS. 4c-4d show the corresponding SNR results, which reflect noise reduction performance. Results from this test show that using the speech suppressor results in SNR improvement of 1.7-3.1 dB for handheld mode and 1 dB for hands-free mode.

### 9. Clamping

Further preferred embodiment methods modify the gain G(k, r) by clamping it to reduce gain variations during background noise fluctuation. In particular, let Gₘᵢₙ be a minimum for the gain (for example, take log Gₘᵢₙ to be something like −12 dB), then clamp G(k,r) by the assignment:

G(k,r)=max{Gₘᵢₙ,G(k,r)}

10. Alternative Transform with MDCT

The foregoing preferred embodiments transformed to the frequency domain using short-time discrete Fourier transform with overlapping windows, typically with 50% overlap. This requires use of 2N-point FFT, and also needs a 4N-point memory for spectrum data storage (twice the FFT points due to the complex number representation), where N represents the number of input samples per processing frame. The modified DCT (MDCT) overcomes this high memory requirement.

In particular, for time-domain signal x(n) at frame r where the rth frame consists of samples with rN≦n≦(r+1)N−1, the MDCT transforms x(n) into X(k,r), k=0, 1, . . . , N−1, defined as:

$$X ( k , r ) = {\sum }_{m = 0}^{2 N - 1} x ( r N + m ) h ( m ) cos \frac{( 2 m + N + 1 ) ( 2 k + 1 ) π}{4 N} ,$$

where h(m), m=0, 1, . . . , 2N−1, is the window function. The transform is not directly invertible, but two successive frames provide for inversion; namely, first compute:

$${x}^{′} ( m , r ) = \frac{2}{N} h ( m ) {\sum }_{k = 0}^{N - 1} X ( k , r ) cos \frac{( 2 m + N + 1 ) ( 2 k + 1 ) π}{4 N}$$

Then reconstruct the rth frame by requiring

x(rN+m)=x′(m+N,r−1)+x′(m,r) for m=0, 1, . . . , N−1.

This becomes the well-known adjacent window condition for h(m):

h(m)²+h(m−+N)²=1 for m=0, 1, . . . , N−1.

A commonly used window is: h(m)=sin [π(2m+1)/2N].

Thus the FFTs and IFFTs in the foregoing and in FIGS. 1a-1b could be replaced by MDCTs and two-frame inverses.

### 11. Modifications

The preferred embodiments can be modified while retaining the speech suppression in the reference noise.

For example, the various parameters and thresholds could have different values or be adaptive, other single-channel noise reduction (speech enhancement) methods (such as, spectral subtraction method, single-channel method based on auditory masking properties, single-channel method based on subspace selection, and etc.) could be an alternative of the MMSE, the speech suppressor system could also be alternated by a noise estimation system.

While the foregoing is directed to embodiments of the present invention, other and further embodiments of the invention may be devised without departing from the basic scope thereof, and the scope thereof is determined by the claims that follow.

What is claimed is:

1. A method of speech-free noise estimation, comprising the steps of:
(a) sample and frame an audio input;
(b) apply noise suppression to the frames to estimate speech content of the frames;
(c) cancel the speech content from the frames to give a speech-free noise estimated frames.

2. A method of noise cancellation, comprising the steps of:
(a) sample and frame both a primary audio input and a noise-reference audio input;
(b) apply speech suppression to the noise-reference frames;
(c) apply a voice activity detector to the primary frames; when there is no voice activity, update the coefficients of an adaptive noise cancellation (ANC) filter;
(d) apply the ANC filter to the speech-free noise estimate to get an estimate of the primary noise; and
(e) subtract the estimate of primary noise from the primary input to get the noise cancelled speech.

3. An adaptive audio noise canceller, comprising:
(a) a primary input and a noise-reference input;
(b) a speech suppressor coupled to the noise-reference input;
(c) a voice activity detector (VAD) coupled to the primary input; and
(d) an adaptive noise cancellation (ANC) filter coupled to the primary input, to the VAD, and to the speech suppressor, wherein the ANC filter is operable to:
(i) when the VAD indicates no voice activity, update filter coefficients of the ANC filter;
(ii) apply the ANC filter to the output of the speech suppressor to get an estimate of noise at the primary input; and
(iii) subtract the estimate of noise at the primary input from an input signal at the primary input.
